(19) United States
(12) Patent Application Publication
(10) Pub. No.: US 2015/0370650 A1
(43) Pub. Date: Dec. 24, 2015

(54) IMAGE PROCESSING APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventor: Yukio TAJIMA, Kanagawa (JP)

(73) Assignee: FUJI XEROX CO., LTD., Tokyo (JP)

(21) Appl. No.: 14/529,533

(22) Filed: Oct. 31, 2014

(30) Foreign Application Priority Data
Jun. 19, 2014 (JP) 2014-126671

(51) Int. Cl. G06F 11/14; G06F 17/30

(52) U.S. Cl. CPC G06F 11/1464; G06F 17/30864

(57) ABSTRACT

An image processing apparatus includes an image processing mechanism, a display device, an input device, a web browser, a first web server, a second web server, and an update unit. The image processing mechanism performs image processing including at least one of image formation on a medium and image reading on a medium. The web browser displays a web page for receiving a user input on the display device and receives a user input via the input device. The first web server which provides the web page in response to a request from the web browser rather than from an external apparatus stores setting information for an application which is executed in accordance with the setting information in response to the request. The second web server receives update information of the setting information from the external apparatus. The update unit updates the stored setting information with the update information.

### CROSS-REFERENCE TO RELATED APPLICATIONS

This application is based on and claims priority under 35 USC 119 from Japanese Patent Application No. 2014-126671 filed Jun. 19, 2014.

### BACKGROUND

(i) Technical Field

The present invention relates to an image processing apparatus, an image processing method, and a non-transitory computer readable medium.

(ii) Related Art

Examples are known in which a local user interface (UI) of an image processing apparatus, such as a printer, a scanner, a digital copier, or a digital multi-function device (a device having functions of a printer, a scanner, a copier, a facsimile, and the like), is implemented by using a web (WWW: world wide web) technology. In the image processing apparatus of this type, a web server and a web browser are installed in the apparatus, and the web server provides UI screen information having the configuration of a web page, for the web browser. The web browser generates an image of the UI screen from the data of the web page, and displays the image on a display apparatus (for example, a touch panel) included in the image processing apparatus. In addition, custom-built applications using various functions of the image processing apparatus are generated as a web application (hereinafter simply also referred to as an “application”) by using HyperText Markup Language (HTML), JavaScript®, and the like, and are installed in the image processing apparatus. In this case, when a user selects execution of an application from a menu or the like on the UI screen of the image processing apparatus, a request for execution of the application is transmitted from the web browser to the web server within the apparatus. In response to the request, the web server executes the application. Setting information of each application is stored in the image processing apparatus. When the application is executed, the corresponding setting information is read.

### SUMMARY

According to an aspect of the invention, there is provided an image processing apparatus including an image processing mechanism, a display device, an input device, a web browser, a first web server, a second web server, and an update unit. The image processing mechanism performs image processing including at least one of a process of forming an image on a medium and a process of reading an image on a medium. The web browser displays a web page for receiving a user input on the display device and receives a user input via the input device. The first web server provides the web page in response to a request from the web browser rather than a request from an external apparatus which is present outside of the image processing mechanism. The first web server stores setting information corresponding to an application. The application is executed in accordance with the setting information in response to the request from the web browser. The second web server receives update information of the setting information inputted from the external apparatus. The update unit updates the setting information stored in the first web server with the update information inputted to the second web server from the external apparatus.

### BRIEF DESCRIPTION OF THE DRAWINGS

Exemplary embodiments of the present invention will be described in detail based on the following figures, wherein:

FIG. 1 is a diagram illustrating an exemplary functional configuration of an image processing apparatus of the related art;

FIG. 2 is a diagram illustrating an exemplary functional configuration of an image processing apparatus of a first exemplary embodiment;

FIG. 3 is a diagram illustrating an exemplary procedure of an update unit according to the first exemplary embodiment;

FIG. 4 is a diagram illustrating an exemplary functional configuration of an image processing apparatus according to a second exemplary embodiment;

FIG. 5 is a diagram illustrating an exemplary procedure of an update unit according to the second exemplary embodiment; and

FIG. 6 is a diagram illustrating an exemplary functional configuration of an image processing apparatus in an example in which a local web server includes an update unit.

### DETAILED DESCRIPTION

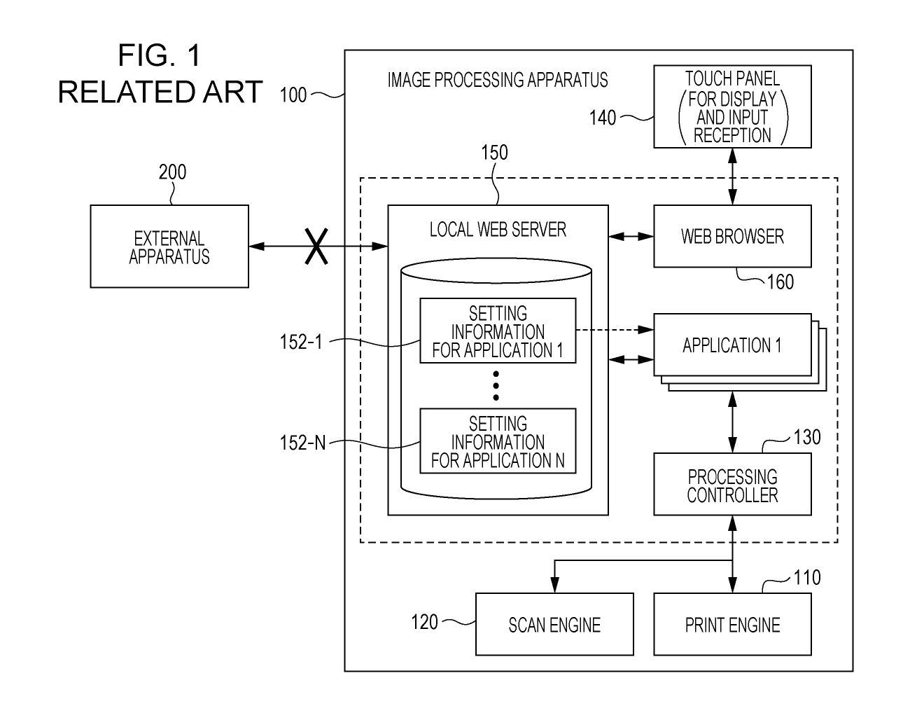

Referring to FIG. 1, an exemplary functional configuration of an image processing apparatus of the related art in which a local UI is implemented by using a web technology will be described.

In an image processing apparatus 100 illustrated in FIG. 1, a print engine 110 is a mechanism for forming (printing) an image on a medium such as paper. A scan engine 120 is a mechanism for optically reading an image on a medium and generating image data representing the image which is read. A processing controller 130 controls the print engine 110 and the scan engine 120, and executes a process indicated in an instruction given by a user. For example, the processing controller 130 converts print data received from a personal computer or the like via a network into image data which may be received by the print engine 110, and supplies the image data to the print engine 110 so that the image data is printed. The processing controller 130 also controls the scan engine 120 so that the scan engine 120 reads a document image, and causes the resulting image data to be stored in a local storage area or to be transmitted to a personal computer or the like on a network. The processing controller 130 causes the print engine 110 to print the image which is read by the scan engine 120, achieving a copy process.

The image processing apparatus 100 having a print function, a scan function, and a copy function is given as an example, but this is merely an example. In addition to these functions, for example, the image processing apparatus 100 may have a facsimile transmission/reception function. Instead, the image processing apparatus 100 may be a single-function device having a printing function, a scan function, or the like. In this regard, the same is true for exemplary embodiments of the present invention described below.

A touch panel 140 which is an apparatus for the local UI of the image processing apparatus 100 displays a UI screen and receives an input through a touch operation performed by a user on the UI screen. Instead of or in addition to the touch panel, the image processing apparatus 100 may include a display apparatus and an input apparatus constituted by mechanical buttons and a numerical keypad, as apparatuses for the local UI.

A UI screen displayed on the touch panel 140 (or the display apparatus for the local UI) is provided by a local web server 150 installed in the image processing apparatus 100, in the form of a web page. That is, the web server 150 supplies a UI web page to a web browser 160 which is similarly installed in the image processing apparatus 100, and the web browser 160 generates an image of the UI screen from the web page data and displays the image on the touch panel 140. The web browser 160 obtains a user input through a touch operation performed on the UI screen, and transmits an HTTP request according to the input, to the local web server 150.

The web browser 160 transmits, for example, an HTTP request for a web page representing the main menu screen to the local web server 150 at startup, and displays the web page supplied in response to the request on the touch panel 140. When a user selects a desired menu item on the main menu web page, the web browser 160 transmits an HTTP request generated from the uniform resource locator (URL) which is set on the selected menu item, to the local web server 150. In the case where the URL which is set on the selected menu item corresponds, for example, to a second menu, the web browser 160 receives a web page of the second menu from the local web server 150. In the case where the URL which is set on the selected menu item corresponds to a web application (designated as an “application” in FIG. 1), the web browser 160 invokes the application. The invoked application executes a process, and transmits the processing result back to the local web server 150. The local web server 150 generates a web page containing the processing result of the application, and transmits the web page to the web browser 160.

In the example in FIG. 1, the local web server 150 may provide applications, the number of which is N, i.e., applications 1 to N, and stores setting information 152-1 to 152-N (hereinafter collectively called “setting information 152” when distinction among them is not needed) corresponding to the applications 1 to N, respectively. An application invoked by the local web server 150 executes a process in accordance with the corresponding setting information 152.

An example of the application is one which performs password authentication for a user. There is another application for collecting lists of print data registered by a user from the image processing apparatus 100 and other image processing apparatuses on a network which collaborate with the image processing apparatus 100, and for generating a print-target selection screen by merging the collected lists. This application has a list of other image processing apparatuses which collaborate with the image processing apparatus 100, as setting information, and refers to the setting information so that lists of print data of the user are collected from each of the image processing apparatuses collaborating with the image processing apparatus 100. There may be an application for generating a screen for print settings, such as the number of copies and whether or not duplex printing is to be performed. On an initial print setting screen provided by the application, default print settings registered by a user are displayed. The user changes the values of the setting items from the default values on the setting screen when necessary. For this application, the local web server 150 stores default print setting information of each user as setting information.

Among the components of the image processing apparatus 100 described above, the functions of the components surrounded with a dashed line, i.e., the processing controller 130, the local web server 150, the web browser 160, and the applications, are achieved by executing programs corresponding to the respective components by using a computer included in the image processing apparatus 100.

As described above, the local web server 150 does not receive a request from an external apparatus 200 which is present outside of the image processing apparatus 100, for security reasons such as protection of information in the web server 150. Therefore, it is not possible for the setting information 152 of each of the applications managed by the local web server 150 to be updated through an instruction from the external apparatus 200. In the configuration of the related art, the setting information may be changed only by inputting information manually on the touch panel 140.

Therefore, a mechanism for updating the setting information of an application while security of the local web server 150 is ensured will be proposed.

### First Exemplary Embodiment

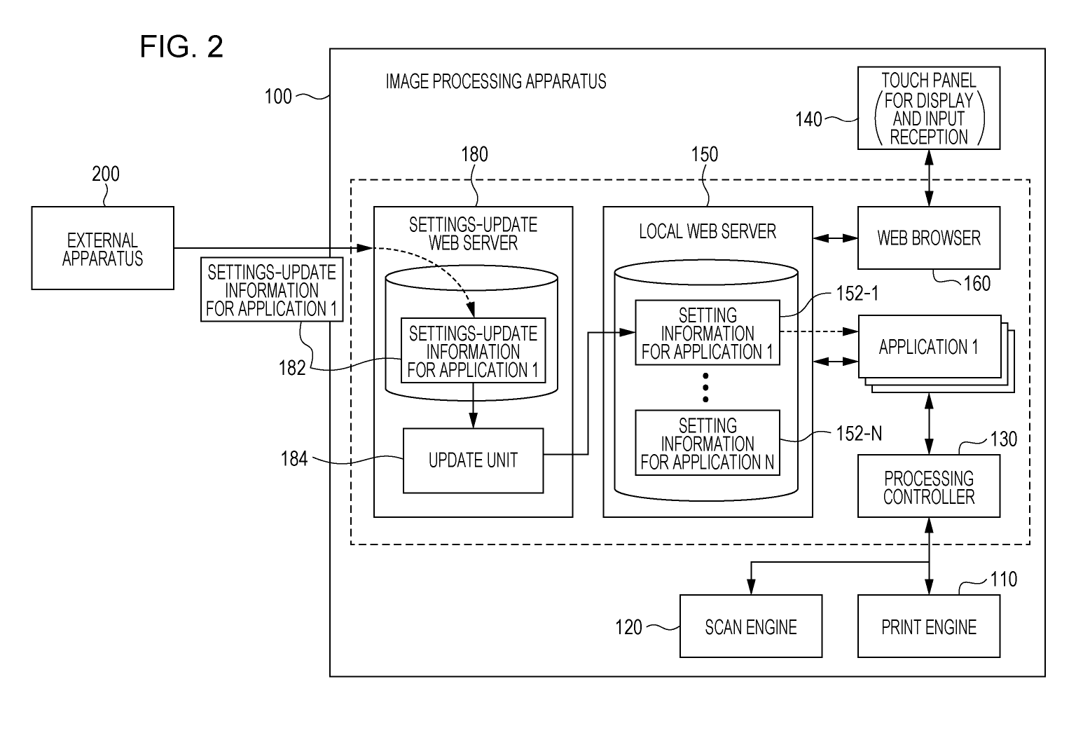

Referring to FIG. 2, an image processing apparatus according to the first exemplary embodiment of the present invention will be described. Among the components of the image processing apparatus 100 in FIG. 2, components similar to those in FIG. 1 are designated with identical reference numerals, and will not be described.

As illustrated in FIG. 2, the image processing apparatus 100 according to the first exemplary embodiment includes a settings-update web server 180 in addition to the local web server 150. The settings-update web server 180 is achieved by executing programs describing functions of the settings-update web server 180 described below, on the computer included in the image processing apparatus 100.

The settings-update web server 180 is configured to receive an HTTP request from apparatuses on the Internet and an intranet, and receives a request for updating the setting information 152 of an application managed by the local web server 150, from the external apparatus 200 which is present outside of the image processing apparatus 100.

In the external apparatus 200, a setting tool (not illustrated) for updating the setting information 152 of an application is installed. The setting tool has, for example, a function of helping generate settings-update information 182 which describes update information of the setting information 152, and a function of uploading the generated settings-update information 182 to the settings-update web server 180.

The settings-update information 182 generated by using the setting tool may be information including the values, after update, of all of the items in the setting information 152 of the corresponding application (i.e., information with which the setting information 152 is replaced as it is). In another example, the settings-update information 182 may include the values of items to be updated in the setting information 152, but not the values of items which are not to be updated. An operator of the external apparatus 200 (for example, a maintenance operator who undertakes maintenance of image processing apparatuses), for example, may refer to a database (not illustrated) managing information about the applications installed in each of the image processing apparatuses 100, and may generate the settings-update information 182 while the operator checks the setting information 152 to be changed in the target image processing apparatus 100.

The settings-update information 182 is associated with unique identification information (referred to as “application identification information”) which describes which application corresponds to the settings-update information 182. For example, when the path of the storage location of the setting information 152 of each of the applications in the local web server 150 is determined, the path information may be used as the identification information of the application (however, this is merely an example).

By using the upload function of the setting tool, the settings-update information 182 and the application identification information which are associated with each other are transmitted to the settings-update web server 180, for example, by using an HTTP POST command. The setting tool may have a function of combining pieces of the settings-update information 182 of multiple applications (and pieces of the application identification information corresponding to the respective pieces of the settings-update information 182) into an archive file and uploading the archive file.

Before receiving a request for updating settings from the external apparatus 200, the settings-update web server 180 may authenticate the external apparatus 200. For example, only an access to a login authentication page from the outside is permitted, and the other accesses from the outside are not permitted. Only after a user operating the external apparatus 200 inputs his/her correct user authentication information (for example, a pair of a user ID and a password) on the login authentication page, a web page for receiving a request for uploading the settings-update information 182 may be provided for the external apparatus 200. The user specifies settings-update information 182 which is prepared, as an upload target on the upload page, and transmits the specification, whereby the settings-update information 182 is uploaded from the external apparatus 200 to the settings-update web server 180.

The settings-update web server 180 communicates with the local web server 150, for example, by using HTTP. The local web server 150 does not receive an HTTP request from the outside of the image processing apparatus 100, but receives an HTTP request from a system on the same computer in the image processing apparatus 100 (for example, the web browser 160). For example, the local web server 150 receives only a request from a loopback address, such as localhost, 127.0.0.1, or ::1. Therefore, the local web server 150 also receives a request from the settings-update web server 180 which is a system on the same computer. In this example, the settings-update web server 180 updates the setting information 152 in the local web server 150 through exchange using HTTP. The transmission source address of a request received by the local web server 150 is not limited to a loopback address, and may be a predetermined address which is not used as a transmission source of a request from the outside in the protocol. The settings-update web server 180 transmits an update request whose transmission source is the predetermined address, to the local web server 150.

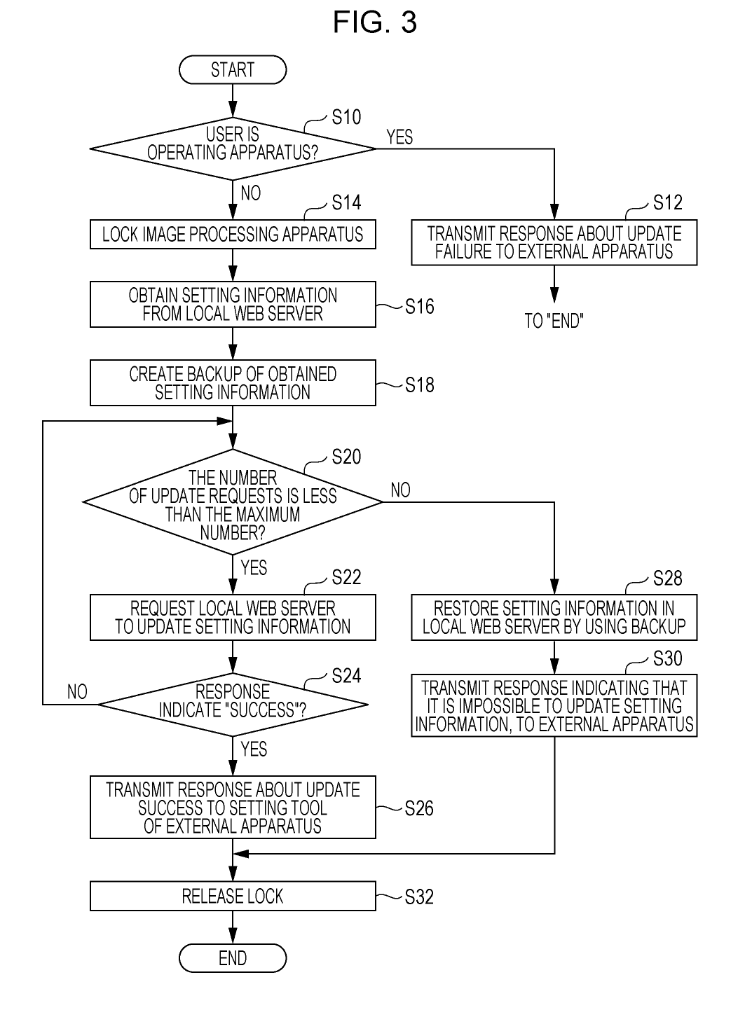

The settings-update web server 180 having received a request for uploading the settings-update information 182 (for example, a request using a POST command) from the external apparatus 200 activates an update unit 184 in response to the request. That is, the URL representing the upload destination of the settings-update information 182 indicates a program of the update unit 184, and the upload request causes the update unit 184 to be executed. The update unit 184 uses the settings-update information 182 transmitted along with the request, to update the setting information 152 of the corresponding application which is managed by the local web server 150. An exemplary update process will be illustrated in FIG. 3.

In the process in FIG. 3, the update unit 184 checks if a user is operating the image processing apparatus 100 (in step S10). A controller (for example, the processing controller 130) of the image processing apparatus 100 monitors whether or not a user is operating an input unit such as the touch panel 140, and the update unit 184 transmits, to the controller, an inquiry about whether or not the image processing apparatus 100 is currently receiving a user operation in step S10. If the result of the inquiry in step S10 indicates that a user is operating the image processing apparatus 100 (the determination result is YES in step S10), the update unit 184 does not update the setting information 152, generates a response information indicating that the update process has failed. The settings-update web server 180 transmits the response information as a response to the HTTP request for updating settings, to the setting tool of the external apparatus 200 (in step S12). In the case where the setting tool of the external apparatus 200 receives the response information indicating that the update has failed, from the settings-update web server 180, after the setting tool waits for a predetermined time, the setting tool transmits again (retries) the request for updating settings. The maximum number of retries may be set. When a response indicating success in the update has failed to be received until the number of retries reaches the maximum number of retries, the setting tool may output a message that the image processing apparatus 100 is busy (receiving a user operation) and that update of settings has failed to be performed.

In step S10, if it is determined that a user is not operating the image processing apparatus 100 (the determination result is NO), the update unit 184 requests the controller of the image processing apparatus 100 to lock the image processing apparatus 100 so that the image processing apparatus 100 is not operated. In response to the request, the controller causes the image processing apparatus 100 to enter the operation lock state, that is, a state in which user operations from the input units are not received (in step S14). In the operation lock state, the update process in step S16 and its subsequent steps is performed.

Thus, in the procedure in FIG. 3, while a user is operating the image processing apparatus 100, the setting information 152 is not updated. When the image processing apparatus 100 is not operated, the image processing apparatus 100 is caused to enter the operation lock state, and the setting information 152 is then updated. While a user is operating the image processing apparatus 100, an application process using the setting information 152 to be updated or a writing process to the setting information 152 may be performed. If the setting information 152 is updated during the application process or the writing process, the processing result may be one which is not expected by the user. Therefore, in the procedure, in order not to produce such an unexpected result, the setting information 152 is updated after the image processing apparatus 100 is caused to enter the state in which a user is not permitted to operate the image processing apparatus 100.

After causing the image processing apparatus 100 to enter the lock state, the update unit 184 obtains the setting information 152 of the application corresponding to the application identification information received along with the settings-update information 182, from the local web server 150 (in step S16). For example, when the application identification information represents a path of the storage location of the setting information 152 of the application, the update unit 184 may transmit an HTTP request for data stored at the path, to the local web server 150. Otherwise, the update unit 184 may refer to information (which is stored in the image processing apparatus 100 in such a manner that the update unit 184 may access the information) about the corresponding relationship between the application identification information and the path of the setting information 152 of the application, thereby obtaining the path of the setting information 152 corresponding to the settings-update information 182 and requesting the path data from the local web server 150.

The update unit 184 creates a backup of the setting information 152 obtained in step S16 and stores the backup (in step S18).

The update unit 184 determines whether or not the number of update requests transmitted to the local web server 150 is less than the predetermined maximum number of retries (in step S20). If the number of update requests is less than the maximum number of retries, the update unit 184 increments the number of update requests by 1, and requests the local web server 150 to update the corresponding setting information 152 (in step S22). For example, when the settings-update information 182 represents the values of all of the items in the corresponding setting information 152 in the same format as that of the setting information 152 (that is, an update version of the setting information 152), the update unit 184 replaces the setting information 152 in the local web server 150 with the settings-update information 182, thereby achieving updating of the setting information 152. Thus, for example, the update unit 184 may transmit a request (for example, an HTTP PUT command) for writing the settings-update information 182 to the path of the setting information 152 specified in step S16, to the local web server 150. When the settings-update information 182 includes only the values of items to be updated in the setting information 152, the update unit 184 may update the values of the update target items in the setting information 152 which is information before update and which is obtained in step S16, with the values of the update target items in the settings-update information 182, thereby generating the setting information 152 after update and transmitting a request for writing the setting information 152 after update to the path of the setting information 152 specified in step S16, to the local web server 150.

In response to the write request from the update unit 184, the local web server 150 overwrites the setting information 152 stored in the local web server 150 with the setting information after update which accompanies the request. If the overwriting succeeds, the local web server 150 transmits a response indicating the success to the update unit 184. If the overwriting fails due to some trouble, the local web server 150 transmits a response indicating the failure to the update unit 184.

The update unit 184 determines whether or not the response to the update request which has been transmitted in step S22, from the local web server 150 indicates success (in step S24). If the determination result is YES (the process has succeeded), the update unit 184 transmits a response indicating that the update has succeeded, as a response to the update request back to the setting tool of the external apparatus 200 (in step S26). If the determination result is NO in step S24, the update unit 184 returns back to step S20.

If it is determined that the number of update requests is less than the maximum number of retries in step S20, the update unit 184 retries the update request. Otherwise, the update unit 184 abandons updating of the setting information 152, and writes the setting information 152 before update which has been backed up in step S18, back to the local web server 150 (in step S28). This writing-back operation is achieved by requesting the local web server 150 to write the setting information 152 before update to the path of the setting information 152, for example, by using a method such as one using an HTTP PUT command. If the update has not succeeded until the number of retries reaches the maximum number of retries, the update unit 184 transmits a response indicating that the update has failed for some reason, as a response to the update request, to the setting tool of the external apparatus 200 (in step S30). This response may be similar to the update failure response transmitted in the case where the image processing apparatus 100 is being operated in step S12. In this case, the setting tool of the external apparatus 200 which receives this response transmits the update request to the settings-update web server 180 again. Another example is that the response indicating the update failure in step S30 is different from the update failure response in step S12. In this case, instead of retrying the update request, the setting tool of the external apparatus 200 which receives the response in step S30 may display a message that it is impossible to update the setting information 152 for some reason, on a screen.

After step S26 or S30, the update unit 184 requests the controller of the image processing apparatus 100 to release the operation lock state (in step S32). Thus, the image processing apparatus 100 returns back to the state in which a user operation may be received. At that time, the update unit 184 may delete the settings-update information 182 received from the external apparatus 200, from the settings-update web server 180. Deletion of the settings-update information 182 reduces a risk of leakage of the settings-update information 182 which occurs in a case where unauthorized access is made to the settings-update web server 180.

Before starting the procedure in FIG. 3, the update unit 184 may check the validity of the settings-update information 182 received from the external apparatus 200. If the settings-update information 182 is not valid, the process does not proceed to step S10 and its subsequent steps, and the update unit 184 may transmit a response indicating that the settings-update information 182 is not valid to the external apparatus 200. In the check of the validity, for example, it is checked if the settings-update information 182 conforms to the predetermined syntax of the settings-update information.

As described above, the apparatus configuration according to the first exemplary embodiment which is illustrated in FIG. 2 causes the external apparatus 200 not to access the local web server 150 directly, ensuring the security of the web pages, the applications, and the like which are provided by the local web server 150. On the other hand, the external apparatus 200 may access the settings-update web server 180 in the image processing apparatus 100 so as to request that the setting information 152 of an application in the local web server 150 be updated. Even if unauthorized access is made to the settings-update web server 180, the configuration in which the settings-update web server 180 does not have the UI information and the applications which are included in the local web server 150 produces a low probability of leakage and unauthorized use of such information.

### Second Exemplary Embodiment

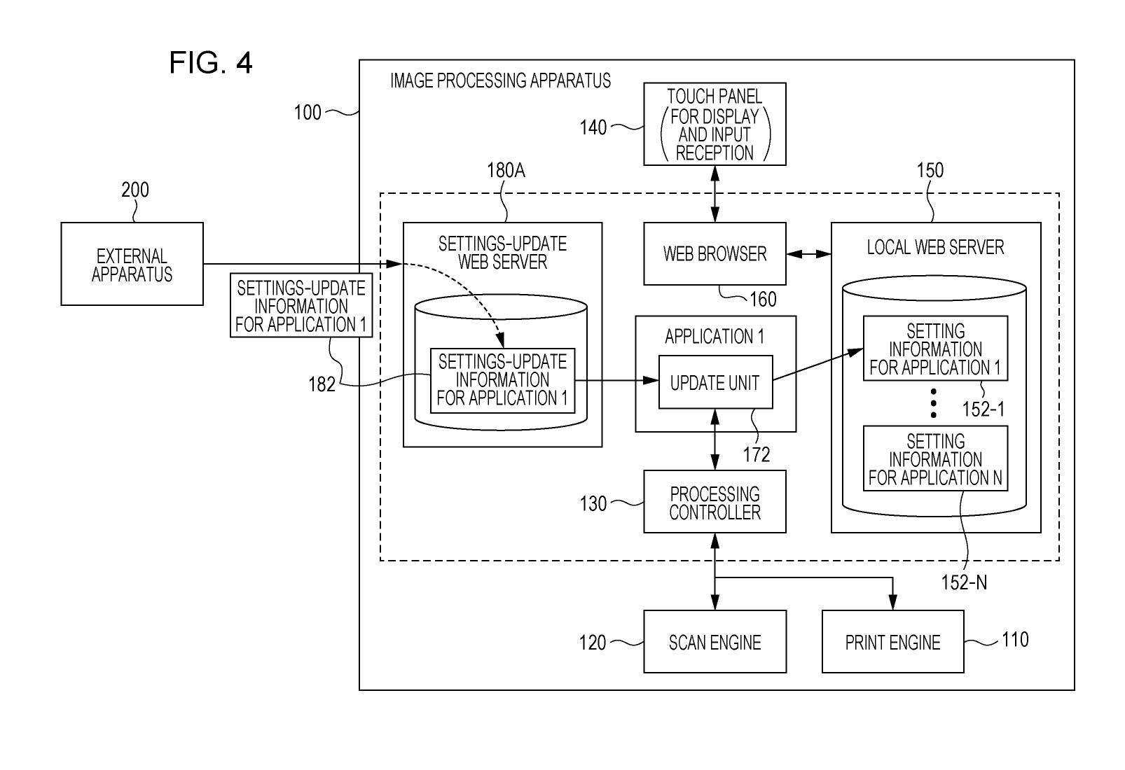

Referring to FIG. 4, a second exemplary embodiment will be described. In FIG. 4, components similar to those in the first exemplary embodiment illustrated in FIG. 2 are designated with identical reference numerals, and will not be described.

Also in the second exemplary embodiment, similarly to the first exemplary embodiment described above, a settings-update web server 180A which receives a request for updating the setting information 152 from the external apparatus 200 is provided for the image processing apparatus 100. In the first exemplary embodiment described above, an update request received by the settings-update web server 180 from the external apparatus 200 is used as a trigger to activate the update unit 184 which updates the setting information 152. In contrast, in the second exemplary embodiment, an application invoked by the local web server 150 calls the function of the update unit 172 included in the application, and the update unit 172 updates the setting information 152 of the application.

When the settings-update web server 180A according to the second exemplary embodiment receives an update request including the settings-update information 182 of an application (“application 1” in FIG. 4) from the setting tool of the external apparatus 200, the settings-update web server 180A converts the settings-update information 182 into the format of content of a web page, and stores the resulting data in association with identification information of the application corresponding to the settings-update information 182. The settings-update web server 180A transmits a response about success in the storing operation to the setting tool of the external apparatus 200. Similarly to the first exemplary embodiment, the settings-update web server 180A may check the validity of the received settings-update information 182 (for example, syntax check). When the settings-update information 182 is not valid, instead of storing the settings-update information 182, the settings-update web server 180A may transmit a response indicating that the settings-update information 182 is not valid, back to the external apparatus 200.

When the web browser 160 invokes an application in response to a user input on a UI screen displayed on the touch panel 140, the invoked application activates the update unit 172. At that time, the application supplies its identification information to the update unit 172.

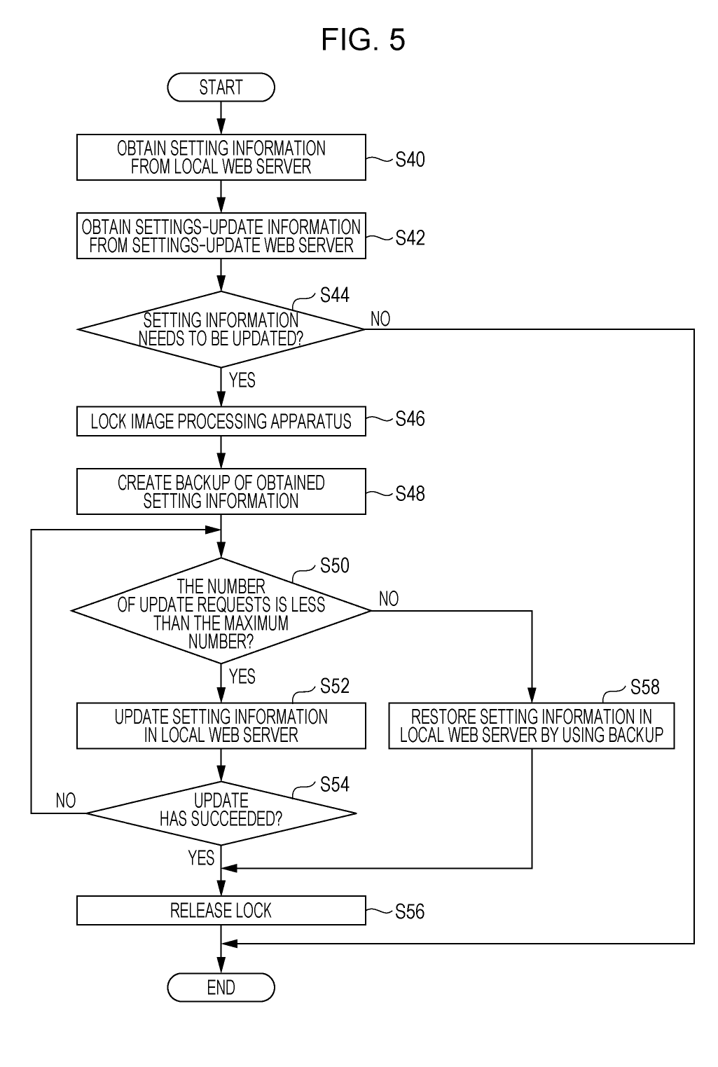

The activated update unit 172 uses the settings-update information 182 of the application stored by the settings-update web server 180A to update the setting information 152 of the application which is stored by the local web server 150. An exemplary detailed procedure of the update process is illustrated in FIG. 5.

In the process in FIG. 5, the activated update unit 172 obtains the setting information 152 of the application which is to be updated, from the local web server 150 (in step S40), and obtains the settings-update information 182 corresponding to the application, from the settings-update web server 180A (in step S42). Since the update unit 172 obtains the identification information of the application which has activated the update unit 172, from the application, the update unit 172 obtains the setting information 152 and the settings-update information 182 which are stored in association with the identification information, in steps S40 and S42.

From the setting information 152 and the settings-update information 182 which are obtained in steps S40 and S42, the update unit 172 determines whether or not the setting information 152 needs to be updated (in step S44). If the settings-update information 182 corresponding to the application fails to be obtained from the settings-update web server 180A in step S42 (that is, the settings-update information 182 itself is not present), it is determined that the setting information 152 does not need to be updated in step S44. If the setting information 152 obtained in step S40 already reflects the update information described in the settings-update information 182 obtained in step S42, it is also determined that the setting information 152 does not need to be updated in step S44. This case occurs after the setting information 152 was updated in accordance with the settings-update information 182, when the settings-update information 182 in the settings-update web server 180A has not been overwritten with new settings-update information of the application which is received from the external apparatus 200.

If it is determined that the update does not need to be performed in step S44, the update unit 172 notifies the application which has activated the update unit 172, of completion of the process, and ends the process.

If it is determined that the update needs to be performed in step S44, similarly to step S14 (FIG. 3) in the first exemplary embodiment, the update unit 172 requests the controller of the image processing apparatus 100 to lock the image processing apparatus 100 (in step S46). The update unit 172 backs up the setting information 152 obtained in step S40 (in step S48).

The process in the subsequent steps is similar to that in step S20 and its subsequent steps in the first exemplary embodiment. That is, the update unit 172 determines whether or not the number of update requests transmitted to the local web server 150 is less than the predetermined maximum number of retries (in step S50). If the number of update requests is less than the maximum number of retries, the update unit 172 increments the number of update requests by 1, and updates the setting information 152 of the application in the local web server 150 (in step S52). When the settings-update information 182 represents the values of all of the items in the corresponding setting information 152 in the same format as that of the setting information 152, the update unit 172 may simply overwrite the settings-update information 182 to the storage location corresponding to the path for the identification information received from the application. When the settings-update information 182 includes only the values of items to be updated in the setting information 152, the update unit 172 may update the values of the update target items in the setting information 152 before update which is obtained in step S40, with the values of the update target items in the settings-update information 182, thereby generating the setting information 152 after update and writing the setting information 152 after update to the path of the setting information 152.

The update unit 172 determines whether or not update of the setting information 152 succeeds (in step S54). If the determination result is “success”, the update unit 172 releases the lock of the image processing apparatus 100 (in step S56), and transmits a response about success in the update to the application which has activated the update unit 172. In response to the response, the application executes its process. If the determination result is NO in step S54, the update unit 172 returns back to step S50.

If it is determined that the number of update requests is less than the maximum number of retires in step S50, the update unit 172 retries the update request. Otherwise, the update unit 172 abandons the update of the setting information 152, and writes the setting information 152 before update which has been backed up in step S48, back to the local web server 150 (in step S58). After step S58, the update unit 172 releases the lock of the image processing apparatus 100 (in step S56), and transmits a response about update failure to the application which has activated the update unit 172.

Also in the second exemplary embodiment, similarly to the first exemplary embodiment, the local web server 150 does not receive direct access from the external apparatus 200, but the settings-update web server 180A and the update unit 172 enable the setting information 152 of the applications managed by the local web server 150 to be updated in response to an instruction from the external apparatus 200 via a network. In the second exemplary embodiment, upon invocation of an application, the update unit 172 checks whether or not update information of the setting information 152 of the application is present. If there is update information, the setting information 152 is updated in accordance with the update information, and the process of the application then starts.

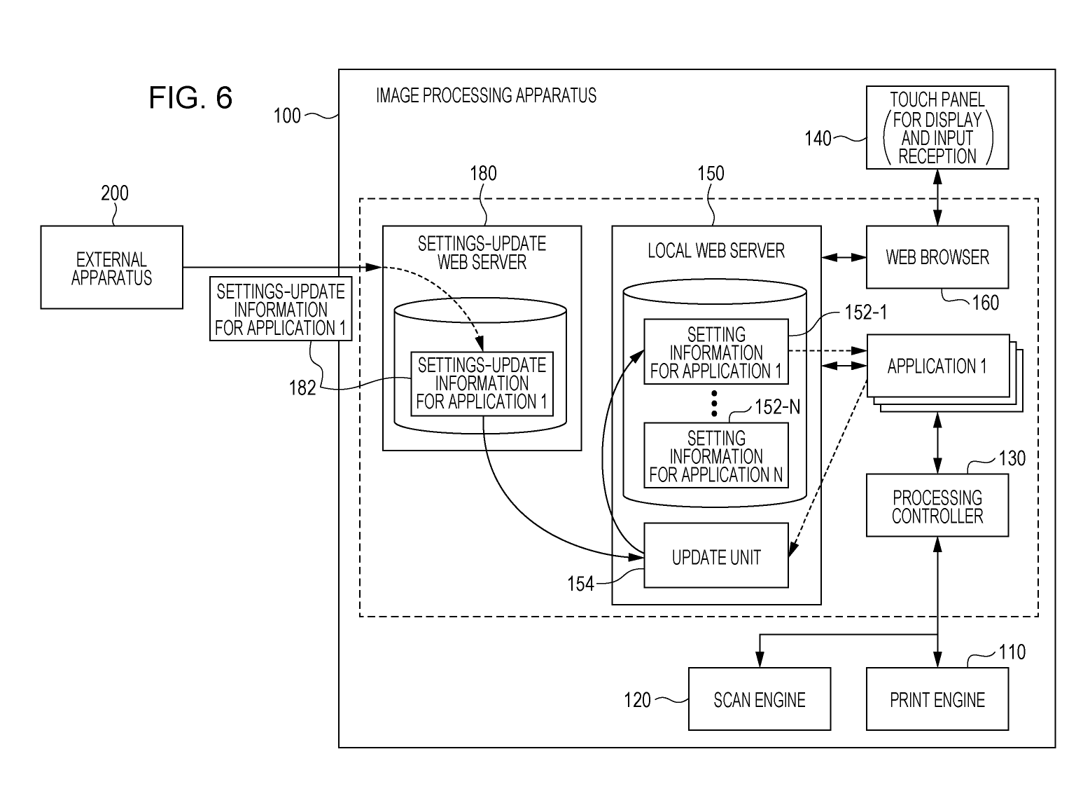

In the example in FIG. 4, the update unit 172 is a function of the application itself, but this is not necessary. The update unit 172 prepared as a program different from the application may be activated by the application. As an example of this modification, as illustrated in FIG. 6, the local web server 150 may provide the service of an update unit 154. In this case, when a web application (application) is invoked in response to an instruction from a user via the touch panel 140 and the web browser 160, the application first requests the service of the update unit 154 from the local web server 150. The procedure of the service performed by the update unit 154 may be similar to that in FIG. 5.

In the image processing apparatus 100 described above as an example, the functional modules in the built-in computer surrounded with a dashed line may be achieved by causing the built-in computer to execute programs describing processes of the functional modules. The built-in computer has a circuit configuration in which, for example, as hardware, a microprocessor such as a central processing unit (CPU), a memory (primary memory), such as a random access memory (RAM) and a read-only memory (ROM), a secondary memory controller which controls a secondary memory, such as a hard disk drive (HDD), a solid state drive (SSD), or a flash memory, various input/output (I/O) interfaces, and a network interface controlling connection to a wireless or wired network are connected to one another, for example, via a bus. A disk drive for reading and/or writing data from/to a portable disk recording medium, such as a compact disc (CD), a digital versatile disc (DVD), or a Blu-ray Disc, and a memory reader/writer for reading and/or writing data from/to a portable nonvolatile recording medium in conformity with any of various standards, such as a flash memory, may be connected to the bus, for example, via an I/O interface. Programs describing the processes of the functional modules described above as an example are stored in a secondary storage, such as a flash memory or an HDD, through a recording medium, such as a CD or a DVD, or through a communication unit such as a network, and are installed in a computer. The programs stored in the secondary storage are read out to the RAM, and are executed by a microprocessor such as the CPU, achieving the functional modules described above as an example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image processing mechanism that performs image processing including at least one of a process of forming an image on a medium and a process of reading an image on a medium;
a display device;
an input device;
a web browser that displays a web page for receiving a user input on the display device and that receives a user input via the input device;
a first web server that provides the web page in response to a request from the web browser rather than a request from an external apparatus which is present outside of the image processing mechanism, the first web server storing setting information corresponding to an application, the application being executed in accordance with the setting information in response to the request from the web browser;
a second web server that receives update information of the setting information inputted from the external apparatus; and
an update unit that updates the setting information stored in the first web server with the update information inputted to the second web server from the external apparatus.

2. The image processing apparatus according to claim 1,
wherein the update unit creates a backup of the setting information stored in the first web server, then updates the setting information stored in the first web server with the update information, and, when the update fails, restores the setting information with the backup.

3. The image processing apparatus according to claim 1,
wherein the update unit is a function of the second web server, and, when the second web server receives the update information from the external apparatus, updates the setting information in the first web server with the received update information.

4. The image processing apparatus according to claim 2,
wherein the update unit is a function of the second web server, and, when the second web server receives the update information from the external apparatus, updates the setting information in the first web server with the received update information.

5. The image processing apparatus according to claim 1,
wherein the second web server stores the update information inputted from the external apparatus, and
wherein the update unit is activated by the application when the application is invoked, and uses the update information stored in the second web server to update the setting information in the first web server.

6. The image processing apparatus according to claim 2,
wherein the second web server stores the update information inputted from the external apparatus, and
wherein the update unit is activated by the application when the application is invoked, and uses the update information stored in the second web server to update the setting information in the first web server.

7. The image processing apparatus according to claim 1,
wherein the second web server stores the update information inputted from the external apparatus, and
wherein the update unit is a function of the first web server, is activated from the application when the application is invoked, obtains the update information from the second web server, and updates the setting information in the first web server with the obtained update information.

8. The image processing apparatus according to claim 2,
wherein the second web server stores the update information inputted from the external apparatus, and
wherein the update unit is a function of the first web server, is activated from the application when the application is invoked, obtains the update information from the second web server, and updates the setting information in the first web server with the obtained update information.

9. A non-transitory computer readable medium storing a program causing a computer to execute a process, the computer being included in an image processing apparatus having an image processing mechanism, a display device, and an input device, the image processing mechanism performing image processing including at least one of a process of forming an image on a medium and a process of reading an image on a medium, the process comprising:
by using a web browser, displaying a web page for receiving a user input on the display device, and receiving a user input via the input device;
by using a first web server, providing the web page in response to a request from the web browser rather than a request from an external apparatus which is present outside of the image processing mechanism, wherein the first web server stores setting information corresponding to an application and the application is executed in accordance with the setting information in response to the request from the web browser;
by using a second web server, receiving update information of the setting information inputted from the external apparatus; and
updating the setting information stored in the first web server with the update information inputted to the second web server from the external apparatus.

10. An image processing method for a computer being included in an image processing apparatus having an image processing mechanism, a display device, and an input device, the image processing mechanism performing image processing including at least one of a process of forming an image on a medium and a process of reading an image on a medium, the method comprising:
by using a web browser, displaying a web page for receiving a user input on the display device, and receiving a user input via the input device;
by using a first web server, providing the web page in response to a request from the web browser rather than a request from an external apparatus which is present outside of the image processing mechanism, wherein the first web server stores setting information corresponding to an application and the application is executed in accordance with the setting information in response to the request from the web browser;
by using a second web server, receiving update information of the setting information inputted from the external apparatus; and
updating the setting information stored in the first web server with the update information inputted to the second web server from the external apparatus.
